(19) United States
(12) Patent Application Publication
(10) Pub. No.: US 2012/0118119 A1
(43) Pub. Date: May 17, 2012

(54) Apparatus for slicing food products

(76) Inventor: Guenther Weber, Gross Nemerow (DE)

(21) Appl. No.: 13/377,128

(22) PCT Filed: May 27, 2010
(86) PCT No.: PCT/EP2010/003229

§ 371 Date: Jan. 30, 2012

(30) Foreign Application Priority Data
Jun. 9, 2009 (DE) 10 2009 024 413.1

(51) Int. Cl. B26D 7/06; B26D 1/12

(52) U.S. Cl. 83/401

(57) ABSTRACT

The invention relates to a device for cutting food products, especially a high-performance slicer, comprising a product feed which feeds one or more products to be cut to a cutting plane along a direction of product conveyance, in which plane at least one cutting knife moves, especially in a rotating and/or revolving motion. The product feed comprises at least one end element which has a product-guiding contact and/or support surface for a front product end region and is exchangeably fastened to a support, a clamping and/or bracing element being mounted on the support for fastening the end element.

The invention relates to an apparatus for slicing food products, in particular to a high-performance slicer, having a product feed which supplies one or more products to be sliced along a product conveying direction to a cutting plane in which at least one cutting blade moves, in particular in a rotating and/or revolving manner, wherein the product feed includes at least one end element which has a product-conducting support surface or contact surface for a front product end region and is replaceably fixed to a carrier.

Food products of different consistency can be sliced at a high cutting sequence with such cutting devices which are also called slicers. The end element serves also to guide the product to be sliced reliably in the proximity of the cutting plane to obtain ideal cutting results in this manner. In this respect, the end element can reach directly up to the cutting plane so that the end element defines a cutting edge which cooperates with the cutting blade during the cutting procedure and is therefore also called a counter-blade. The end element is in particular exposed to substantial forces during the cutting operation in these cases so that it has to be designed with corresponding stability and must be sufficiently supported.

It is necessary in practice to replace the end element, for example for cleaning purposes or on product switches, since especially adapted end elements may be used for each product type. In order to ensure a secure fixing of the end element despite the high cutting forces which arise during operation, the end element was previously screwed to a base carrier. A secure fixing of the end element is hereby ensured. However, a change of the end element is comparatively time-consuming due to the releasing and reestablishing of the screw connections required for this purpose.

It is the object of the invention to further develop a slicing apparatus of the initially named kind such that a replacement of the end element is simplified and simultaneously a secure fixing and a stable support of the end element is ensured.

This object is satisfied by the features of claim 1 and in particular in that a clamping device and/or tensioning device is provided for fixing the end element to the carrier. The replacement of the end element can hereby be substantially simplified, with it having been found that it is sufficient for the taking up of the high cutting forces occurring during the cutting operation to fix the end element to the carrier by means of a clamping device and/or tensioning device.

The fixing of the end element to the carrier preferably takes place free of connection means. That is in this respect no connection means such as screws are required in addition to the clamping device and/or tensioning device. The clamping device and/or tensioning device is in particular the only means by which the fixing of the end element to the carrier takes place.

The clamping device and/or tensioning device can have precisely one fixing member. The dismantling and assembly of the end element can hereby be carried out particularly simply since the user only has to handle one single fixing member.

A shape-matched connection can preferably be established at least regionally between the end element and the carrier. The required force take-up can hereby be ensured in a particularly reliable manner.

Provision can furthermore be made that the end element can be brought into a pre-assembly position on the carrier and can be fixed in the pre-assembly position by the clamping device and/or tensioning device. The attachment to the carrier can in particular take place by pushing on or plugging on. The user can hereby first bring the end element in a simple manner into a clearly defined pre-assembly position, whereupon—starting from this clearly defined position of the end element—the fixing of the end element to the carrier is ensured with the aid of the clamping device and/or tensioning device.

In an embodiment, the end element can be brought into engagement with the carrier at one side, whereas the end element can be fixed at another side by the clamping device and/or tensioning device in a sense securing the engagement. The engagement between the end element and the carrier can in particular be a shape-matched connection. It can in particular be established by engagement, latching, engaging behind, engaging around, hanging in, hooking in or catching.

Provision can furthermore be made that the clamping device and/or tensioning device includes at least one fixing member which has a first section and a second section, with the first section being able to be brought into engagement with the end element and the second section being able to be brought into engagement with the carrier. The engagement between the fixing member and the carrier is in particular a shape-matched connection. It can in particular be established by engagement, latching, engaging behind, engaging around, hanging in, hooking in or catching.

Further possible embodiments of the invention are set forth in the dependent claims, in the description and in the drawing.

The invention will be described in the following by way of example with reference to the drawing. There are shown:

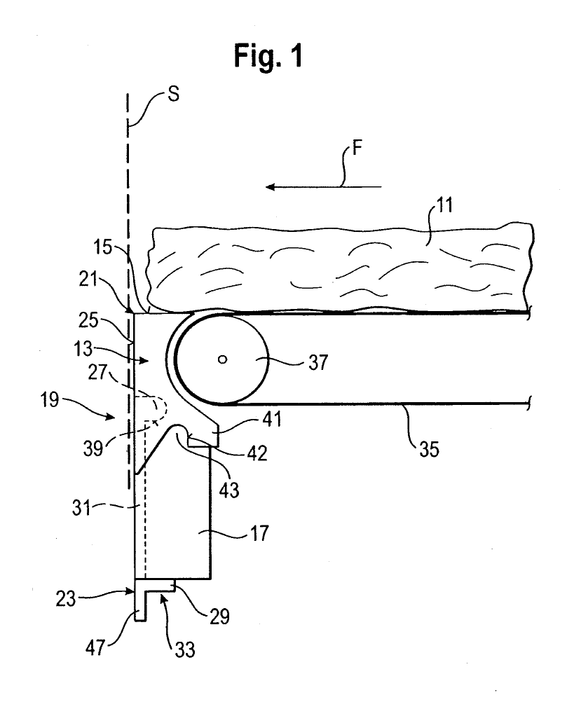

FIG. 1 schematically, a side view of a part of a slicer in accordance with the invention;

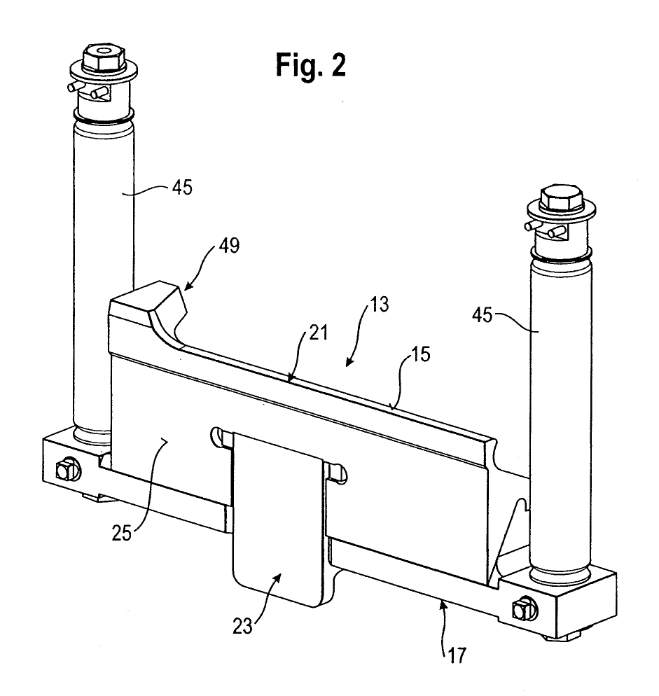

FIG. 2 a perspective view of an embodiment of the invention; and

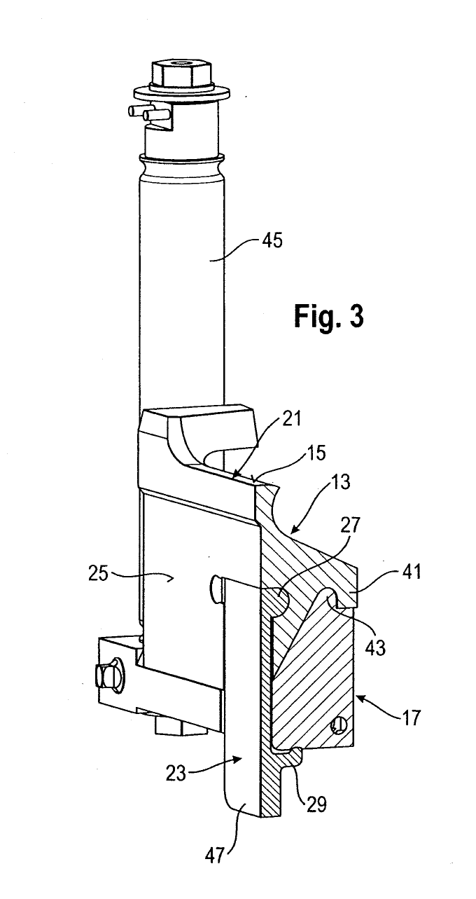

FIG. 3 the embodiment of FIG. 2 in a sectional view.

The slicer shown only schematically and in part in FIG. 1 includes a product feed having a continuous conveyor belt 35 which is guided about a deflection roller 37. The continuous conveyor belt 35 is driven by means, not shown, to supply a supported product 11 in a product conveying direction F to a cutting plane S in which a cutting blade, not shown, moves whose blade defines the cutting plane S. The cutting blade can, for example, be a circular blade both revolving in a planetary motion and rotating or an only rotating scythe-like blade.

The means for supplying the product can generally be any desired. While the product support is here formed by the driven continuous belt 35, the product support can also be designed as stationary, with the product 11 being advanced in the product conveying direction F by means of a product holder or gripper which engages into the read product end and which has a drive. The slicer can be designed for slicing a single product 11 or for the simultaneous slicing of a plurality of products 11.

The guidance of the front end region of the product 11 close to the cutting plane S takes place by an end element 13 which has a support surface 15 for the front product end which adjoins the product support surface formed by the continuous conveying belt 35 in the product conveying direction F and in this manner bridges the intermediate space between the front end of the product support and the cutting plane S.

The contact surface 15 of the end element 13 is ended by a cutting edge 21 which is directly adjacent to the cutting plane S. The cutting edge 21 cooperates as a counter-blade with the rotating or revolving cutting blade. An end element 13 provided with such a cutting edge 21 is itself frequently called a cutting edge in practice.

The previous and the following statements on the end element 13 and its fixing relate to such an end element which has a support surface extending parallel to the product support surface—here the continuous belt conveyor belt 35. These statements apply analogously to differently oriented end elements (not shown), for example for such an end element which has a lateral contact surface for the front product end which extends perpendicular to the product support surface of the continuous conveyor belt 35 and of the shown end element 13.

The fixing of the end element 13 takes place in the embodiment shown here at a carrier 17, and indeed by means of a clamping device and/or tensioning device 19 which will be described in more detail in the following. The carrier 17 to which the end element 13 is fixed can generally be designed as desired.

In a mutually connected state, that is with an effective clamping device and/or tensioning device 19, there is a shape-matched connection between the end element 13 and the carrier 17. The upper side of the carrier 17 is provided with a projection 43 which engages into a correspondingly shaped recess 42 at the lower side of the end element 13. Consequently, the holding projection 43 of the carrier 17 is engaged around by a holding section 41 of the end element 13 at the rear-viewed in the product conveying direction F. The end element 13 can consequently simply be placed or pushed onto the carrier 17 for assembly.

The fixing of this pre-assembly position takes place by a fixing member 23 of the clamping and/or tensioning device 19. The fixing member 23 cooperates at a first section 27 with the end element 13 and at a second section 29 with the carrier 17. For this purpose, the first section 27 is in engagement with a corresponding mount 39 which is formed at the end element 13, whereas the second section 29 of the fixing member 23 engages behind the lower side of the carrier 17.

The end element 13 and the carrier 17 can consequently be clamped by means of the fixing member 23 in a direction extending approximately perpendicular to the support surface 15. Since the end element 13 is simultaneously in shape-matched engagement at its section 27 and its recess 42 with the carrier 17, a secure fixing and a relatively large contact surface is ensured overall between the end element 13 and the carrier 17.

The manner of fixing in accordance with the invention does not require any screw connection and is easily able to take up the forces acting on the end element 13 during the cutting operation such that an ideal cooperation is ensured between the cutting edge 21 and the cutting blade.

Only the second section 29 of the fixing member 23 has to be pulled off the lower side of the carrier 17 for dismantling the end element 13. The end element 13 can then be simply removed from the carrier 17.

The user can grip the fixing member 23 both for assembly and for dismantling at an actuation section 47 which can also project further beyond the second section 29 than is shown in FIG. 1.

As can in particular also be seen from FIGS. 2 and 3, the mount 39 for the fixing member 23 is formed at the front side 25 of the end element 13 facing in the product conveying direction F. The mount 39 and the fixing member 23 are matched to one another such that the corresponding side of the fixing member 23 terminates approximately flush with the front side 25 of the end element 13 so that the cutting blade can move with its blade edge into the cutting plane S without impediment.

It has been shown that—as in particular shown in FIG. 2—a single fixing member 23 is sufficient to achieve a secure fixing of the end element 13 at the carrier 17. With the exception of a side region 49 and of the region serving for the mounting of the fixing member 23, the end element 13 is a sectional element having a constant cross-section. This applies analogously to the region of the carrier 17 cooperating with the end element 13. The holding section 41 and the holding projection 43 are consequently rib-like or bead-like sections extending transversely to the product conveying direction F, whereas the recess has a correspondingly groove-like or channel-like extent.

The shape-matched connection between the end element 13 and the carrier 17 is consequently effective substantially over the whole width of the product feed. This alone already provides a stable seat of the end element 13 on the carrier 17 and an ideal taking up of the forces acting on the end element 13 during the cutting operation. The fixing member 23 active in the described manner is sufficient for the fixing of this seat.

The holders 45 shown at both sides of the end element 13 serve for the attachment of the carrier 17 to the slicer and have no significance beyond this for the invention so that these holders 45 will not be looked at in any more detail.

### REFERENCE NUMERAL LIST

11 product
13 end element
15 support surface and/or contact surface
17 carrier
19 clamping device and/or tensioning device
21 cutting edge
23 fixing member
25 side of the end element
27 first section
29 second section
31 limb
33 limb
35 continuous conveyor belt
37 deflection roller
39 mount
41 holding section
42 recess
43 holding projection
45 holder
47 actuation section
49 side region
F product conveying direction
S cutting plane

1-14. (canceled)

15. An apparatus for slicing food products comprising
a product feed which supplies one or more products (11) to be sliced along a product conveying direction (F) to a cutting plane (S) in which at least one cutting blade moves,
wherein the product feed includes at least one end element (13) which has a product-conducting support surface and/or contact surface (15) for a front product end region and is replaceably fixed to a carrier (17); and
wherein a clamping device and/or tensioning device (19) is provided for fixing the end element (13) to the carrier (17).

16. An apparatus in accordance with claim 15, wherein said apparatus is a high-performance slicer.

17. An apparatus in accordance with claim 15, wherein said at least one cutting blade moves in a rotating and/or revolving manner.

18. An apparatus in accordance with claim 15, wherein the end element (13) defines a cutting edge (21) which is adjacent to the cutting plane (S) and terminates the support surface and/or contact surface (15).

19. An apparatus in accordance with claim 15, wherein the fixing of the end element (13) to the carrier (17) takes place free of connection means.

20. An apparatus in accordance with claim 15, wherein the fixing of the end element (13) to the carrier (17) takes place without screws.

21. An apparatus in accordance with claim 15, wherein the fixing of the end element (13) to the carrier (17) takes place only through the clamping device and/or tensioning device (19).

22. An apparatus in accordance with claim 15, wherein the clamping device and/or tensioning device (19) has precisely one fixing member (23).

23. An apparatus in accordance with claim 15, wherein a shape-matched connection can be established at least regionally between the end element (13) and the carrier (17).

24. An apparatus in accordance with claim 15, wherein the end element (13) can be brought into a pre-assembly position on the carrier (17) and can be fixed in the pre-assembly position by the clamping device and/or tensioning device (19).

25. An apparatus in accordance with claim 24, wherein the end element (13) can be brought into the pre-assembly position on the carrier (17) by pushing or plugging on.

26. An apparatus in accordance with claim 15, wherein the end element (13) is in engagement with the carrier (17) at one side and can be fixed at another side by the clamping device and/or tensioning device (19) in a sense securing the engagement.

27. An apparatus in accordance with claim 26, wherein the engagement of the end element with the carrier takes place by means of engagement, latching, engaging behind, engaging around, handing in, hooking in or catching.

28. An apparatus in accordance with claim 26, wherein the engagement of the end element with the carrier takes place in a shape-matched manner.

29. An apparatus in accordance with claim 15, wherein the end element (13) and/or the carrier (17) is formed as a sectional element which extends perpendicular to the product conveying direction (F) and which has a constant cross-sectional shape at least over a substantial part of its length.

30. An apparatus in accordance with claim 15, wherein the clamping device and/or tensioning device (19) cooperates with a side (25) of the end element (13) facing in the product conveying direction (F).

31. An apparatus in accordance with claim 15, wherein at least one fixing member (23) of the clamping device and/or tensioning device (19) can be received in a side (25) of the end element (13) facing in the product conveying direction (F) such that the fixing member (23) is lowered in the side (25) or at least terminates substantially flush with the side (25).

32. An apparatus in accordance with claim 15, wherein the clamping device and/or tensioning device (19) cooperates with a lower side of the carrier (17).

33. An apparatus in accordance with claim 15, wherein at least one fixing member (23) of the clamping device and/or tensioning device (19) has a first section (27) and a second section (29), with the first section (27) being able to be brought into engagement with the end element (13) and the second section (29) being able to be brought into engagement with the carrier (17).

34. An apparatus in accordance with claim 33, wherein the second section (29) can be brought into engagement with the carrier (17) in a shape-matched manner.

35. An apparatus in accordance with claim 33, wherein the second section (29) can be brought into engagement with the carrier (17) by means of engagement, latching, engaging behind, engaging around, hanging in, hooking in or catching.

36. An apparatus in accordance with claim 15, wherein the fixing member (23) has at least two limbs (31, 33) which extend at an angle to one another, with the first section (27) being formed at the one limb (31) and the second section (29) being formed at the other limb (33).

37. An apparatus in accordance with claim 36, wherein the at least two limbs (31, 33) extend at a right angle to one another.
